(19) United States
(12) Patent Application Publication
(10) Pub. No.: US 2006/0279599 A1
(43) Pub. Date: Dec. 14, 2006

(54) Image forming apparatus displaying print data storage duration and method thereof

(75) Inventor: Byung-uck Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/439,256

(22) Filed: May 24, 2006

(30) Foreign Application Priority Data
Jun. 9, 2005 (KR) 10-2005-0049274

(51) Int. Cl. B41J 29/393

(52) U.S. Cl. 347/19

(57) ABSTRACT

An image forming apparatus and method are provided for displaying the duration of print data storage, and include a storage unit for storing information about retention durations of previously printed data, a computing unit for computing a remaining duration for the print data based on the information on the retention duration and computing a ratio of the remaining duration to the retention duration, a graphic processing unit for generating a predetermined graphic image corresponding to the ratio provided by the computing unit, and a display unit for displaying the graphic image generated by the graphic processing unit. Accordingly, a user can easily check the duration of print data storage.

### CROSS-REFERENCE TO RELATED APPLICATIONS

This application claims the benefit under 35 U.S.C. §119(a) of Korean Patent Application No. 10-2005-0049274 filed in the Korean Intellectual Property Office on Jun. 9, 2005, the entire disclosure of which is incorporated herein by reference.

### BACKGROUND OF THE INVENTION

1. Field of the Invention

The present invention relates in general to an image forming apparatus for displaying the duration of print data storage and a method thereof. More specifically, the present invention relates to an image forming apparatus for displaying the remaining duration relative to the retention duration specified for each print data of a graphic image and a method thereof.

2. Description of the Related Art

Technical advances in electronics and wide-spread use of computers have also brought growing popularity in computer peripherals. Such computer peripherals include external devices for facilitating the use of computers. Image forming apparatuses, such as scanners, printers and combo (multi-function) machines, are good examples of such.

Among them, printers could be said to be the most representative computer peripheral. As many manufacturers have been heavily focused on the development of a low cost, high quality printer, diverse printer models are now available in the market. A user in an example operation, prepares a document using a given application unit in a personal computer (PC) and inputs a print command. Then, a printer driver of the PC converts the document into the printing language the printer can recognize, i.e., the print data. In doing so, prepared print data is transferred to the printer to be printed out.

Some of the newly-developed image forming apparatus further include a reprint function. The reprint function enables the user to repeatedly print the same data printed before, simply by inputting a print command. To this end, an image forming apparatus that supports the reprint function usually retains the print data for a predetermined duration. Also, the image forming apparatus periodically searches for print data whose retention durations have expired, and erases such data if any are found.

However, a major drawback of the above-described image forming apparatus is that the user has no access to check the storage duration of each print data. That is, the related art image forming apparatus displays only the storage duration specified for each print data, or expresses the storage duration expiration time in figures. Therefore, the user can not conveniently check the remaining duration of each print data. Moreover, in the case where there is a number of print data having been printed out at least once, the user can not distinguish which print data storage duration has reached the expiration time. Unfortunately, this results in some print data being erased unexpectedly.

Accordingly, a need exists for a system and method for effectively and efficiently displaying the remaining duration relative to the retention duration specified for each print data.

### SUMMARY OF THE INVENTION

It is, therefore, an object of embodiments of the present invention to substantially solve the above and other problems, and provide an image forming apparatus and method for displaying a predetermined graphic image that specifies the remaining duration of the retention duration set for each pre-stored print data, whereby a user can easily and selectively recognize the storage duration of the print data.

To achieve the above and other objects and advantages, an image forming apparatus is provided, comprising a storage unit for storing information about retention durations of previously printed data, a computing unit for computing a remaining duration for the print data based on the information on the retention duration and for computing a ratio of the remaining duration to the retention duration, a graphic processing unit for generating a predetermined graphic image corresponding to the ratio provided by the computing unit, and a display unit for displaying the graphic image generated by the graphic processing unit.

Preferably, the image forming apparatus further comprises a timer for counting up to a current time and outputting information on the current time, and the computing unit computes the remaining duration of the print data using the information on the current time output from the timer.

In an exemplary embodiment, the computing unit compares the remaining duration with a first predetermined threshold, and if the remaining duration exceeds the first threshold, it computes the ratio in day units.

In an exemplary embodiment, if the remaining duration is below the first threshold, the computing unit computes the ratio in hour units.

Preferably, the image forming apparatus further comprises a control unit for comparing the remaining duration with a second predetermined threshold, and if the remaining duration is below the second threshold, controlling the graphic processing unit and the display unit for changing a display state of the graphic image.

In an exemplary embodiment, the graphic image is expressed with a bar graph, a progressive bar graph, each defining the ratio by length, and/or a pie graph, defining the ratio by degrees of an angle.

Preferably, the display unit displays at least one of information on the remaining duration and the retention duration at one side within the graphic image.

Another aspect of embodiments of the present invention provides a method for displaying duration of print data storage of an image forming apparatus storing information about retention durations of previously printed data, the method comprising the steps of computing a remaining duration for the print data based on the information on the retention duration, generating a predetermined graphic image corresponding to the remaining duration, and displaying the graphic image.

In an exemplary embodiment, the step for computing the remaining duration of the print data comprises the sub-steps of counting elapsed time up to a current time and outputting information on the current time, computing a storage expiration time of the print data by adding a start time of the print data storage to the retention duration, and computing the remaining duration by subtracting the current time from the storage expiration time.

In an exemplary embodiment, the step for generating the predetermined graphic image corresponding to the remaining duration comprises the sub-steps of computing a ratio of the remaining duration to the retention duration, and generating a graphic image corresponding to the ratio.

In an exemplary embodiment, the step for computing the ratio of the remaining duration to the retention duration comprises the sub-steps of comparing the remaining duration with a first predetermined threshold, and if the remaining duration exceeds the first threshold, computing the ratio in day units. Moreover, if the remaining duration is below the first threshold, the ratio is computed in hour units.

Preferably, the method further comprises the steps of comparing the remaining duration with a second predetermined threshold, and if the remaining duration is below the second threshold, changing a display state of the graphic image.

In an exemplary embodiment, the graphic image is expressed with a bar graph, a progressive bar graph, each defining the ratio by length, and/or a pie graph, defining the ratio by degrees of an angle.

In an exemplary embodiment, at least one of information on the remaining duration and the retention duration is displayed at one side within the graphic image.

### BRIEF DESCRIPTION OF THE DRAWINGS

The above and other aspects and features of embodiments of the present invention will become more apparent by describing certain embodiments of the present invention with reference to the accompanying drawings, in which:

FIG. 1 is a block diagram illustrating a configuration of an exemplary image forming apparatus according to an embodiment of the present invention;

FIG. 2 illustrates an example of a bar graphic image displayed in an image forming apparatus according to an embodiment of the present invention;

FIG. 3 illustrates an example of a pie graphic image displayed in an image forming apparatus according to an embodiment of the present invention;

FIG. 4 illustrates an example of a progressive bar graphic image displayed in an image forming apparatus according to an embodiment of the present invention;

FIG. 5 is a flow chart illustrating an exemplary method of displaying the duration of print data storage according to an embodiment of the present invention; and

FIG. 6 is a flow chart illustrating an exemplary method of displaying the duration of print data storage according to another embodiment of the present invention.

Throughout the drawings, like reference numerals will be understood to refer to like parts, components and structures.

### DETAILED DESCRIPTION OF THE EXEMPLARY EMBODIMENTS

Exemplary embodiments of the present invention will now be described herein below with reference to the accompanying drawings.

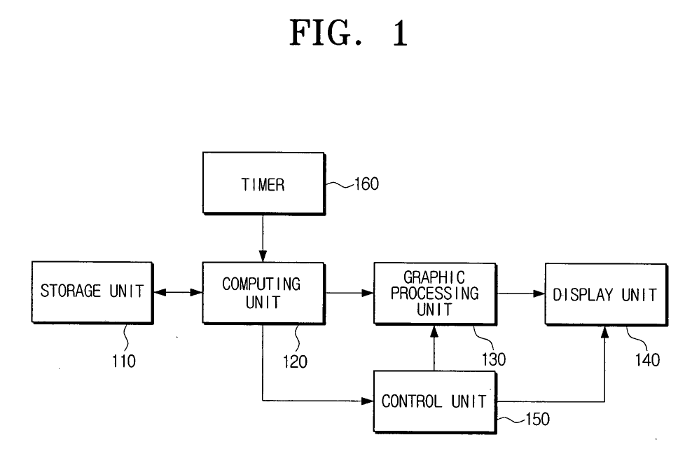

FIG. 1 is a block diagram illustrating a configuration of an exemplary image forming apparatus according to an embodiment of the present invention. As can be seen in the drawing, the image forming apparatus comprises a storage unit 110, a computing unit 120, a graphic processing unit 130, a display unit 140, a control unit 150, and a timer 160.

The storage unit 110 stores print data having been printed out at least once and information about their retention durations. The retention duration tells how long the print data is going to be stored in the image forming apparatus. The retention duration may be arbitrarily set by a user or automatically set to a predetermined default value for all print data. Also, the information on the retention durations comprises information regarding the start time of data storage, i.e., the exact point in time when the print data is started to be stored.

The computing unit 120 computes a remaining duration for each print data based on the information on the retention duration provided by the storage unit 110. The remaining duration is obtained by subtracting the current time from the storage expiration time for the print data of concern. The storage expiration time is obtained by adding the start time of data storage to the designated retention duration for the print data. After obtaining the remaining duration, the computing unit 120 computes a ratio of the retention duration to the remaining duration. In this case, the computing unit 120 obtains the ratio by applying different methods according to the value (or amount) of the remaining duration. In detail, the computing unit 120 first compares the remaining duration with a first predetermined threshold, and if the remaining duration is greater than the first threshold it computes a ratio using Equation (1) below,
A=(Remaining duration/Retention duration)×100=(E−C)/(E−S)×100, Equation (1)
wherein A denotes a ratio, E denotes storage expiration time of each print data, S denotes start time of data storage, i.e., the exact point in time when the print data starts to be stored, and C denotes a current time. Here, the ratio A expresses the percentage of the remaining duration in the total retention duration. The current time is provided by the timer 160. That is, the timer 160 counts elapsed time up to the current time and thereby outputs information on the current time to the computing unit 120.

However, if the remaining duration is less than the first threshold, the computing unit 120 computes a ratio using Equation (2) below,
A=Remaining duration/α×100=(E−C)/α×100, Equation (2)
wherein α denotes the first threshold.

In an example for illustrative purposes, assume that the first threshold and the retention duration are set as 24 hours and 100 days, respectively. If the remaining duration is 48 hours, a ratio A (48 hours/24 hours) becomes 2, according to Equation (1). Then assume that 25 hours have lapsed since then and the remaining duration is now 23 hours. In this case, since the remaining duration (i.e., 23 hours) is less than the first threshold (i.e., 24 hours), the ratio A is computed by applying Equation (2). The resulting ratio is about 96 according to Equation (2).

The graphic processing unit 130 generates a predetermined graphic image corresponding to a ratio computed in the computing unit 120. Examples of the graphic image include a bar graph, progressive bar graph, and pie graph, but are not limited thereto. In the case of the bar graph and the progressive bar graph, a ratio is expressed by the length of each graph. In the case of the pie graph, a ratio is expressed by the angular measure (or degrees of an angle) of the graph.

The display unit 140 displays a graphic image generated by the graphic processing unit 130. An LCD panel, LED, or such device, may be used as the display unit 140.

The control unit 150 compares the remaining duration computed by the computing unit 120 with a second predetermined threshold. If the remaining duration is less than the second threshold, the control unit 150 controls the graphic processing unit 130 and the display unit 140 to change a display state of the graphic image. In detail, the graphic processing unit 130 and the display unit 140 changes for example, under the control of the control unit 150, the color of the graphic image or blinks the graphic image. In this manner, the user can easily check that the remaining duration of data storage is going to run out soon. Here, the second threshold may be arbitrarily set by the user.

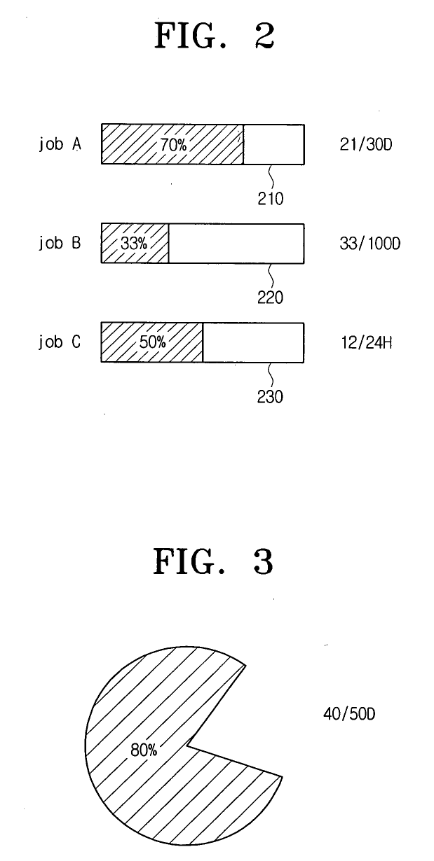

FIGS. 2 through 4 illustrate examples of graphic images generated by the graphic processing unit 130, respectively. Among them, FIG. 2 shows a bar graph according to an embodiment of the present invention. In the drawing of FIG. 2, a plurality of print data jobs A, B and C storage durations are plotted in bar graphs 210, 220, and 230. The length of each bar graph 210, 220, and 230 is marked differently with respect to the retention duration, or 24 hours.

In detail, the remaining durations of the print data A and B exceed the first threshold, i.e., 24 hours. Therefore, the ratios are computed with respect to the retention duration (100%) according to Equation (1). That is, the ratio of the print data A is for example (21/30)×100=70, which means that 70% of the entire bar graph 210 corresponds to the remaining duration. The ratio of the print data B is for example (33/100)×100=33, which means that 33% of the entire bar graph 220 corresponds to the remaining duration. However, the remaining duration of the print data C is 12 hours for example, which is below the first threshold. In this case, the ratio is computed with respect to the first threshold, i.e., 24 hours (100%) according to Equation (2). Thus, the ratio of the print data C is (12/24)×100=50, which means that 50% of the entire bar graph 230 corresponds to the remaining duration. To provide more accurate information to the user, the remaining durations may be indicated by numbers within the bar graphs 210, 220, and 230. Also, to clarify the time units (such as, day or hour units) of the bar graphs 210, 220, and 230, the remaining durations are expressed as 21/30D, 33/100D, and 12/24H, respectively, to the right of the image.

FIG. 3 shows a pie graph according to an embodiment of the present invention. In the drawing of FIG. 3, the retention duration is set to 50 days and the remaining duration is 40 days for example. In this case, the ratio is (40/50)×100=80, according to Equation (1). Therefore, 80% of a total of 360 degrees, i.e., 288 degrees, represents the remaining duration. As in FIG. 2, the remaining duration may be specified by numbers within the pie graph and to clarify the time units (such as, day or hour units) of the pie graph, the remaining duration is expressed as 40/50D to the right of the image.

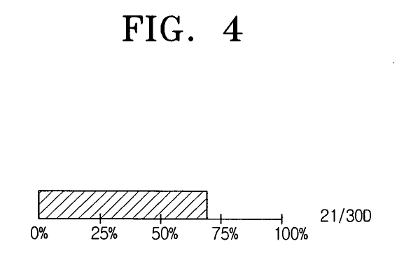

FIG. 4 shows a progressive bar graph according to an embodiment of the present invention. The length of the graph in FIG. 4 is determined using substantially the same methods as in FIG. 2. Namely, if 21 days out of 30 days are left for example, the ratio is 70, which means 70% of the entire progressive bar graph represents the remaining duration and to clarify the time units (such as, day or hour units) of the progressive bar graph, the remaining duration is expressed as 21/30D to the right of the image.

The control unit 150 checks the retention duration assigned to each print data in the storage 110 at predetermined, regular intervals. As such, any print data whose retention durations are expired are automatically erased.

Alternatively, in yet other embodiments of the present invention the controller 150 may check the retention duration of each print data only when the user inputs a storage duration display command through a button or a touch screen provided to the main body of the image forming apparatus in order to check the storage duration of the print data of interest, or in the case of a special event. Consequently, the computation load can be reduced.

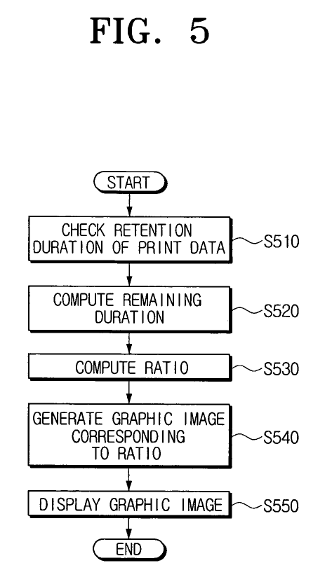

FIG. 5 is a flow chart illustrating an exemplary method of displaying the duration of print data storage according to an embodiment of the present invention. Referring to FIG. 5, the image forming apparatus checks the information on the retention duration of pre-stored print data of interest at step (S510). The information on the retention duration may comprise information regarding the start time of data storage, i.e., the exact point in time for starting to store the print data. Accordingly, the retention duration is added to the start time of data storage to compute the storage expiration time. Then, the remaining duration can be computed by subtracting the current time from the storage expiration time at step (S520).

As such, a ratio of the remaining duration to the entire retention duration or a predetermined amount of time is computed at step (S530).

Once the ratio is obtained, the image forming apparatus generates a predetermined graphic image corresponding to the magnitude of the ratio at step (S540). As aforementioned, the graphic image can be expressed with one of bar graphs, progressive bar graphs and pie graphs, which represent the magnitude of the ratio by length (bar and progressive bar graphs) or degrees of an angle (pie graphs).

The generated graphic image is then displayed at step (S550) to help the user more easily recognize the remaining duration for the print data of interest.

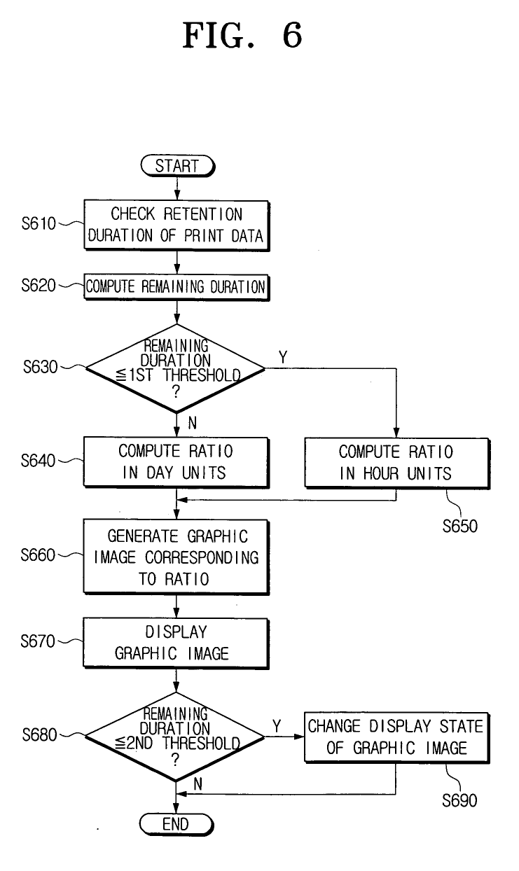

FIG. 6 is a flow chart illustrating an exemplary method of displaying the duration of print data storage according to another embodiment of the present invention. Referring to FIG. 6, the image forming apparatus first checks the information on the retention duration of print data of interest at step (S610), and computes the remaining duration thereof at step (S620).

Next, the image forming apparatus compares the remaining duration with the first predetermined threshold and decides the equation to use at step (S630). For example, if the remaining duration exceeds the first threshold, the image forming apparatus applies Equation (1) and computes a ratio in day units at step (S640). However, if the remaining duration is below or equal to the first threshold, the image forming apparatus applies Equation (2) and computes a ratio in hour units at step (S650).

Afterward, the image forming apparatus generates a graphic image corresponding to the ratio at step (S660) and displays the image to the user at step (S670).

Additionally, the image forming apparatus compares the remaining duration with the second predetermined threshold at step (S680), and warns the user that the retention duration of print data of interest is getting close to the expiration time. That is, if the remaining duration is below or equal to the second threshold, a display state of the graphic image is changed at step (S690). To this end, the image forming apparatus changes the color of the graphic image or blinks the graphic image for example. However, if the remaining duration exceeds the second threshold, the existing display state is maintained as it is. In this manner, even though a list of print data may be displayed, the user can easily see which print data retention duration is close to the expiration time. Here, the second threshold may be arbitrarily set by the user. However, it is desirable to set the ratio to be the same as the first threshold which is the reference for changing the day unit to the hour unit. In doing so, the user is warned that not only the retention duration for the print data of interest is close to expiration, but also that the time unit has changed.

As described above, the image forming apparatus of embodiments of the present invention graphically displays the duration of print data storage for user's convenience. Especially, in order to warn the user about any print data whose retention duration is close to expiration, the image forming apparatus changes the display state of the corresponding graphic image. This provides an additional major convenience to the user.

Although exemplary embodiments of the present invention have been described, it will be understood by those skilled in the art that the present invention should not be limited to the described embodiments, but that various changes and modifications can be made within the spirit and scope of the present invention as defined by the appended claims.

What is claimed is:

1. An image forming apparatus for displaying a remaining duration for print data, comprising:
a storage unit for storing information about retention durations of previously printed data;
a computing unit for computing a remaining duration for the print data based on the information on the retention duration, and computing a ratio of the remaining duration to the retention duration;
a graphic processing unit for generating a predetermined graphic image corresponding to the ratio provided by the computing unit; and
a display unit for displaying the graphic image generated by the graphic processing unit.

2. The apparatus of claim 1, further comprising:
a timer for counting up to a current time and outputting information on the current time, and wherein the computing unit computes the remaining duration of the print data using the information on the current time output from the timer.

3. The apparatus of claim 2, wherein the computing unit is configured to compute the ratio using the following equation:
A=(Remaining duration/Retention duration)×100=(E−C)/(E−S)×100,
wherein A denotes a ratio, E denotes a storage expiration time of each print data, S denotes a start time of data storage, and C denotes a current time.

4. The apparatus of claim 3, wherein the computing unit is configured to compare the remaining duration with a first predetermined threshold, and if the remaining duration is less than the first threshold, computing the ratio using the following equation:
A=Remaining duration/α×100=(E−C)/α×100,
wherein α denotes the first threshold.

5. The apparatus of claim 4, further comprising:
a control unit for comparing the remaining duration with a second predetermined threshold, and if the remaining duration is below the second threshold, controlling at least one of the graphic processing unit and the display unit for changing a display state of the graphic image.

6. The apparatus of claim 5, wherein the graphic image comprises at least one of:
a bar graph, defining the ratio by length;
a progressive bar graph, defining the ratio by length; and
a pie graph, defining the ratio by degrees of an angle.

7. The apparatus of claim 6, wherein the display unit is configured to display at least one of information on the remaining duration and the retention duration at one side within the graphic image.

8. A method for displaying duration of print data storage of an image forming apparatus storing information about retention durations of previously printed data, the method comprising the steps of:
computing a remaining duration for print data based on information on a retention duration of each;
generating a predetermined graphic image corresponding to the remaining duration; and
displaying the graphic image.

9. The method of claim 8, wherein the step for computing the remaining duration for the print data comprises the sub-steps of:
counting an elapsed time up to a current time and outputting information on the current time;
computing a storage expiration time of the print data by adding a start time of the print data storage to the retention duration; and
computing the remaining duration by subtracting the current time from the storage expiration time.

10. The method of claim 9, wherein the step for generating the predetermined graphic image corresponding to the remaining duration comprises the sub-steps of:
computing a ratio of the remaining duration to the retention duration; and
generating a graphic image corresponding to the ratio.

11. The method of claim 10, wherein the ratio of the remaining duration to the retention duration is computed using the following equation:
A=(Remaining duration/Retention duration)×100=(E−C)/(E−S)×100,
wherein A denotes a ratio, E denotes a storage expiration time of each print data, S denotes a start time of data storage, and C denotes a current time.

12. The method of claim 11, wherein the step for computing the ratio of the remaining duration to the retention duration comprises the sub-steps of:
comparing the remaining duration with a first predetermined threshold; and
if the remaining duration is below the first threshold, computing the ratio using the following equation:
A=Remaining duration/α×100=(E−C)/α×100,
wherein α denotes the first threshold.

13. The method of claim 12, further comprising the steps of:
comparing the remaining duration with a second predetermined threshold; and
if the remaining duration is below the second threshold, changing a display state of the graphic image.

14. The method of claim 13, wherein the graphic image comprises at least one of:
a bar graph, defining the ratio by length;
a progressive bar graph, defining the ratio by length; and
a pie graph, defining the ratio by degrees of an angle.

15. The method of claim 14, further comprising the step of:
displaying at least one of information on the remaining duration and the retention duration at one side within the graphic image.
